(19) United States
(12) Patent Application Publication
(10) Pub. No.: US 2025/0037953 A1
(43) Pub. Date: Jan. 30, 2025

(54) ELECTROMAGNETIC RELAY

(71) Applicant: OMRON Corporation, Kyoto-shi, Kyoto (JP)

(72) Inventors: Kohei OTSUKA, Kyoto-shi, Kyoto (JP); Hiroyuki IWASAKA, Kyoto-shi, Kyoto (JP); Ryota MINOWA, Kyoto-shi, Kyoto (JP); Shinichi OGAWA, Kyoto-shi, Kyoto (JP); Ayata HORIE, Kyoto-shi, Kyoto (JP)

(21) Appl. No.: 18/716,151

(22) PCT Filed: Nov. 16, 2022
(86) PCT No.: PCT/JP2022/042468

§ 371 Date: Jun. 4, 2024

(30) Foreign Application Priority Data
Dec. 13, 2021 (JP) 2021-201592

(51) Int. Cl. H01H 50/42; H01H 50/44; H01H 50/54

(52) U.S. Cl. CPC H01H 50/42; H01H 50/546; H01H 50/44

(57) ABSTRACT

An electromagnetic relay includes a first fixed terminal with a first fixed contact; a movable contact piece with a first movable contact on a first surface thereof facing the first fixed contact; a drive device with drive shaft to move the movable contact piece; a contact case; and a guide wall. The guide wall is connected to an inner surface of the contact case. The guide wall leads a first airflow around the first fixed contact and the first movable contact toward a second surface of the movable contact piece, which is on the side of the movable contact piece that is opposite to the first side. The first airflow is caused by current flowing between the first fixed contact and the first movable contact.

### CROSS-REFERENCE TO RELATED APPLICATION

This application is the U.S. National Phase of International Application No. PCT/JP2022/042468, filed on Nov. 16, 2022. That application claims priority to Japanese Patent Application No. 2021-201592, filed Dec. 13, 2021. The contents of those two applications are incorporated by reference herein in their entireties.

### FIELD

The present invention relates to an electromagnetic relay.

### BACKGROUND

Conventionally, electromagnetic relays for opening and closing electric circuits have been known. The electromagnetic relay described in Japanese Patent Application Publication No. 2017-079109 is a plunger-type electromagnetic relay and includes a contact case, a fixed terminal, a fixed contact, a movable contact, a movable contact piece, and a drive device. The contact case accommodates the fixed contact, the movable contact, and the movable contact piece.

In an electromagnetic relay, when a large current such as a short circuit current flows through the fixed contact and the movable contact, sometimes at least one of the fixed contact and the movable contact melts and scatters. In this case, to avoid the occurrence of an arc between the contacts, it is preferable to weld the contacts to make them in a closed condition. However, if the drive device is configured to have a large driving force to ensure the contact force of the contacts for welding of the contacts, the drive device may be enlarged in size.

### SUMMARY

An electromagnetic relay in accordance with the claimed invention increases the contact force of the contacts when at least one of the fixed contact and the movable contact has melted and scattered.

The electromagnetic relay according to one aspect of the claimed invention includes a first fixed terminal, a first fixed contact, a second fixed terminal, a second fixed contact, a movable contact piece, a first movable contact, a second movable contact, a drive shaft, a drive device, a contact case, and a guide wall. The first fixed contact is connected to the first fixed terminal. The second fixed contact is connected to the second fixed terminal and is disposed apart from the first fixed contact in a first direction. The movable contact piece includes a first surface facing the first fixed contact and the second fixed contact, and a second surface opposite to the first surface. The first movable contact is disposed on the first surface of the movable contact piece and faces the first fixed contact in a second direction, the second direction including a contact direction toward the first fixed contact and a separation direction away from the first fixed contact. The second movable contact is disposed on the first surface of the movable contact piece and faces the second fixed contact. The drive shaft is connected to the movable contact piece. The drive device is configured to move the movable contact piece in the second direction via the drive shaft. The contact case accommodates the first fixed contact, the second fixed contact, the first movable contact, the second movable contact, and the movable contact piece. The contact case includes a first outer wall facing the first surface of the movable contact piece, a second outer wall facing the second surface of the movable contact piece, and a third outer wall disposed to a side of the movable contact piece and connected to the first outer wall and the second outer wall. The guide wall is connected to an inner surface of the contact case. The guide wall leads a first airflow in the vicinity of the first fixed contact and the first movable contact toward the second surface of the movable contact piece, wherein the first airflow occurs due to a current that flows between the first fixed contact and the first movable contact.

In the electromagnetic relay, for example, the first airflow that occurs due to a short circuit current flowing between the first fixed contact and the first movable contact is led to the second surface of the movable contact piece by the guide wall. With this configuration, the movable contact piece is pressed in the contact direction by the first airflow guided to the second surface. As a result, the contact force of the first movable contact to the first fixed contact can be increased. That is, in the case where at least one of the first fixed contact and the first movable contact melts and scatters, the contact force of the contacts can be increased.

The guide wall may include a first guide surface, the first guide surface being disposed to a side of the movable contact piece, extending from an inner surface of the third outer wall in the first direction and in the separation direction, and being slanted with respect to the second surface of the movable contact piece. In this case, the first guide surface assists the first airflow to be guided to the second surface of the movable contact piece.

The guide wall may include a second guide surface, the second guide surface extending from an inner surface of the second outer wall toward the movable contact piece and facing the first guide surface in the first direction. In this case, the first guide surface and the second guide surface further assist the first airflow to be guided to the second surface of the movable contact piece.

The second guide surface may be slanted with respect to the second surface of the movable contact piece and may face the second surface of the movable contact piece in the second direction. In this case, the second guide surface further assists the first airflow to be guided to the second surface of the movable contact piece.

The guide wall may include a third guide surface, the third guide surface being disposed to a side of the first fixed terminal, extending in the second direction from an inner surface of the third outer wall toward the first fixed terminal, and facing the first guide surface in the second direction. In this case, the third guide surface further assists the first airflow to be guided to the second surface of the movable contact piece.

The guide wall may include a third guide surface, the third guide surface being disposed to a side of the first fixed terminal and extending in the second direction from an inner surface of the third outer wall toward the first fixed terminal. In this case, the third guide surface further assists the first airflow to be guided to the second surface of the movable contact piece.

The third guide surface may extend from an inner surface of the third outer wall in the second direction and in the contact direction and be slanted with respect to the second surface of the movable contact piece. In this case, the third guide surface further assists the first airflow to be guided to the second surface of the movable contact piece.

The guide wall may include a fourth guide surface, the fourth guide surface being disposed to a side of the movable contact piece, extending from an inner surface of the third outer wall in a third direction orthogonal to the first and second directions and extending in the separation direction, and being slanted with respect to the second surface of the movable contact piece. In this case, the fourth guide surface further assists the first airflow to be guided to the second surface of the movable contact piece.

The guide wall may include a fifth guide surface, the fifth guide surface extending from an inner surface of the second outer wall toward the movable contact piece and facing the fourth guide surface in the third direction. In this case, the fifth guide surface further assists the first airflow to be guided to the second surface of the movable contact piece.

The fifth guide surface may be slanted with respect to the second surface of the movable contact piece and face the second surface of the movable contact piece in the second direction. In this case, the fifth guide surface further assists the first airflow to be guided to the second surface of the movable contact piece.

The guide wall may include a sixth guide surface, the sixth guide surface being disposed to a side of the first fixed terminal, extending in the third direction from an inner surface of the third outer wall toward the first fixed terminal, and facing the fourth guide surface in the second direction. In this case, the sixth guide surface further assists the first airflow to be guided to the second surface of the movable contact piece.

The guide wall may include a sixth guide surface, the sixth guide surface disposed to a side of the first fixed terminal and extending from an inner surface of the third outer wall toward the first fixed terminal in the third direction that is orthogonal to the first and second directions. In this case, the sixth guide surface further assists the first airflow to be guided to the second surface of the movable contact piece.

The sixth guide surface may extend from an inner surface of the third outer wall in the third direction and the contact direction and may be slanted with respect to the second surface of the movable contact piece. In this case, the sixth guide surface further assists the first airflow to be guided to the second surface of the movable contact piece.

The movable contact piece may have, in a third direction, a dimension that is smaller than a dimension of the first fixed terminal within the contact case in the third direction that is orthogonal to the first and second direction directions. In this case, the first airflow flows more easily between the movable contact piece and the third outer wall in the third direction.

The movable contact piece may have, in the second direction, a dimension that is smaller than a distance from the first fixed terminal to the second fixed terminal within the contact case. In this case, the first airflow flows more easily between the movable contact piece and the third outer wall in the second direction.

The second surface of the movable contact piece may have a shape that is recessed toward the first outer wall. In this case, the movable contact piece can be effectively pressed in the contact direction by the first airflow guided to the second surface.

The electromagnetic relay may further include an interlocking member configured to move in conjunction with the movable contact piece. The interlocking member may be disposed on the second surface of the movable contact piece and have a shape recessed toward the second surface of the movable contact piece. In this case, the movable contact piece can be effectively pressed in the contact direction by the first airflow guided to the second surface via the interlocking member.

The first fixed terminal may include a contact support portion supporting the first fixed contact, and an extension portion extending from the contact support portion toward the third outer wall in a direction approaching the movable contact piece. In this case, the first airflow is easily guided to the second surface of the movable contact piece by the extension portion.

The first fixed terminal may be a plate terminal, and include a contact support portion supporting the first fixed contact, and a longitudinal portion disposed to a side of the movable contact piece and extending from the contact support portion toward the first guide surface. In this case, the longitudinal portion assists the first airflow to be guided to the second surface of the movable contact piece.

The contact case may be comprised of material different from material of the guide wall. In this case, the degree of freedom in design increases.

The guide wall may be comprised of resin. In this case, gas is generated from the guide wall due to an arc or a temperature rise inside the contact case. With this configuration, the pressure inside the contact case can be increased, thereby promoting the flow of the first airflow.

The electromagnetic relay may further include a magnet section for extending an arc, which occurs between the first fixed contact and the first movable contact, toward the guide wall. In this case, the flow of the first airflow can be efficiently controlled.

### BRIEF DESCRIPTION OF THE DRAWINGS

FIG. 1 is a schematic cross-sectional diagram of an electromagnetic relay in accordance with the claimed invention in an open state.

FIG. 2 is a schematic cross-sectional diagram of an electromagnetic relay in accordance with the claimed invention in a closed state.

FIG. 3 is a schematic diagram of a contact case viewed from above.

FIG. 4 is a schematic cross-sectional diagram of a movable contact piece and surrounding portions in a closed state.

FIG. 5 is a diagram illustrating a modification of a guide wall.

FIG. 6 is a diagram illustrating a modification of a guide wall.

FIG. 7 is a diagram illustrating a modification of a guide wall.

FIG. 8 is a diagram illustrating a modification of a guide wall.

FIG. 9 is a diagram illustrating a modification of a guide wall.

FIG. 10 is a diagram illustrating a modification of a guide wall.

FIG. 11 is a diagram illustrating a modification of a guide wall.

FIG. 12 is a diagram illustrating a modification of a movable contact piece.

FIG. 13 is a diagram illustrating a modification of an electromagnetic relay.

FIG. 14 is a diagram illustrating a modification of a first fixed terminal.

FIG. 15 is a diagram illustrating a modification of a first fixed terminal.

FIG. 16 is a diagram illustrating a modification of a contact case.

FIG. 17 is a diagram illustrating a modification of a contact case.

FIG. 18 is a diagram illustrating a modification of an electromagnetic relay.

FIG. 19 is a diagram illustrating a modification of an electromagnetic relay.

### DETAILED DESCRIPTION

Hereinafter, one embodiment of an electromagnetic relay 100 according to one aspect of the claimed invention will be described with reference to the drawings. It should be noted that, when the drawings are referenced, the direction indicated by the arrow Z is the up-down direction, the direction indicated by the arrow Z1 is the upward direction, the direction indicated by the arrow Z2 is the downward direction, the direction indicated by the arrow X is the left-right direction, the direction indicated by the arrow X1 is the left direction, the direction indicated by the arrow X2 is the right direction, the direction indicated by the arrow Y is the front-rear direction, the direction indicated by the arrow Y1 is the front direction, and the direction indicated by the arrow Y2 is the rear direction. These directions are defined for convenience of description, and do not limit the arrangement directions of the electromagnetic relay 100.

It should also be noted that the left-right direction in the present embodiment is an example of the first direction, and the up-down direction in the present embodiment is an example of the second direction. The upward direction in the present embodiment is an example of a contact direction Z1, and the downward direction in the present embodiment is an example of a separation direction Z2. The front-rear direction in the present embodiment is an example of the third direction.

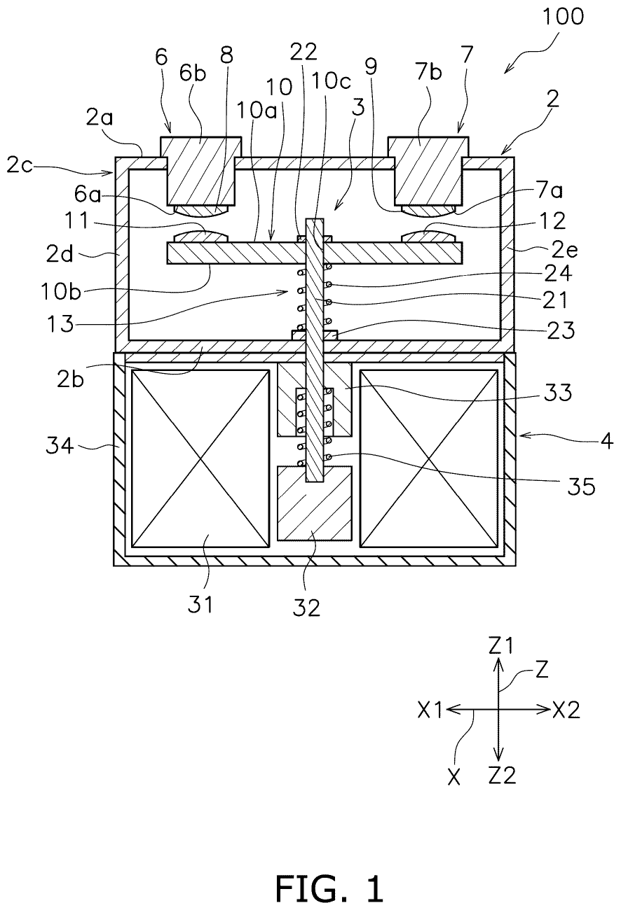

FIG. 1 is a schematic cross-sectional diagram of an electromagnetic relay 100 according to the first embodiment. As shown in FIG. 1, the electromagnetic relay 100 includes a contact case 2, a contact device 3, a drive device 4, and a guide wall 5 (see FIG. 4).

The contact case 2 has a substantially rectangular box shape and is comprised of insulating material. The contact case 2 may be comprised of ceramic or metal material such as aluminum.

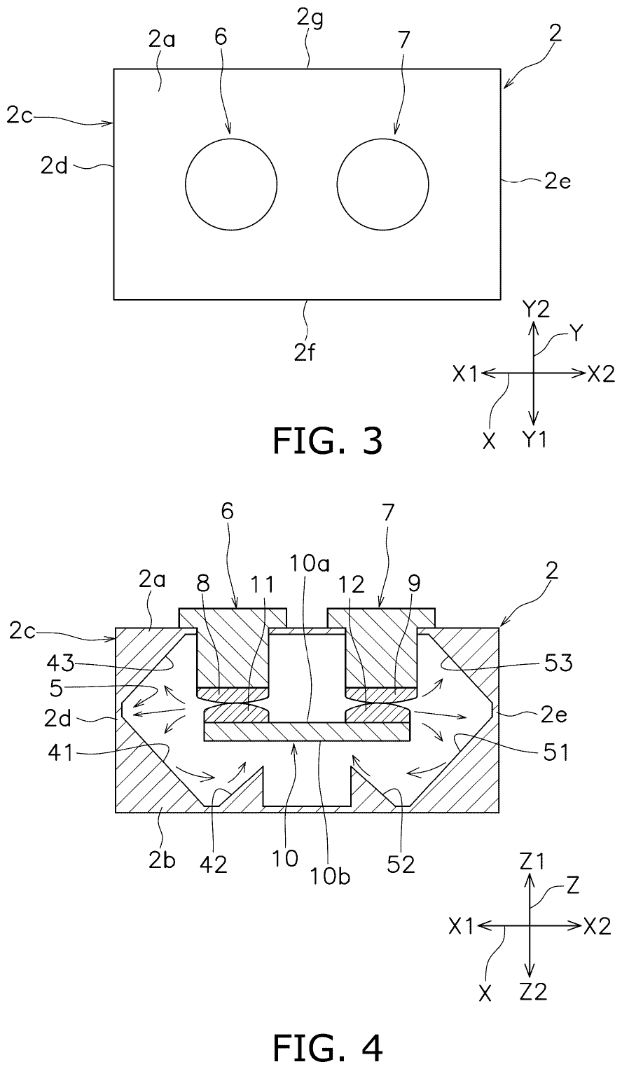

FIG. 3 is a diagram of the contact case 2 as viewed from above. As shown in FIGS. 1 and 3, the contact case 2 includes a top wall 2a, a bottom wall 2b, and a side wall 2c. The top wall 2a, the bottom wall 2b, and the side wall 2c define a space for accommodating the contact device 3.

The top wall 2a is an example of the first outer wall. The bottom wall 2b is an example of the second outer wall. The side wall 2c is an example of the third outer wall. The top wall 2a and the bottom wall 2b have a rectangular shape when viewed from the up-down direction and extend in a direction perpendicular to the up-down direction. The bottom wall 2b is disposed apart from the top wall 2a in the up-down direction. The bottom wall 2b is disposed below the top wall 2a and faces the top wall 2a in the up-down direction.

The side wall 2c is arranged between the top wall 2a and the bottom wall 2b and is connected to the top wall 2a and the bottom wall 2b. The side wall 2c includes a left side wall 2d, a right wall 2e, a front wall 2f, and a rear side wall 2g. The left side wall 2d and the right wall 2e extend in a direction perpendicular to the left-right direction. The left side wall 2d extends from the left end of the top wall 2a to the left end of the bottom wall 2b. The right wall 2e faces the left side wall 2d in the left-right direction. The right wall 2e extends from the right end of the top wall 2a to the right end of the bottom wall 2b. The front wall 2f and the rear side wall 2g extend in a direction perpendicular to the front-rear direction. The front wall 2f extends from the front end of the top wall 2a to the front end of the bottom wall 2b. The rear side wall 2g faces the front wall 2f in the front-rear direction. The rear side wall 2g extends from the rear end of the top wall 2a to the rear end of the bottom wall 2b.

The contact device 3 includes a first fixed terminal 6, a second fixed terminal 7, a first fixed contact 8, a second fixed contact 9, a movable contact piece 10, a first movable contact 11, a second movable contact 12, and a movable mechanism 13. The first fixed contact 8, the second fixed contact 9, the movable contact piece 10, the first movable contact 11, and the second movable contact 12 are accommodated in the contact case 2.

The first fixed terminal 6 and the second fixed terminal 7 are cylindrical terminals and extend in the up-down direction. The first fixed terminal 6 and the second fixed terminal 7 extend from inside to the outside of the contact case 2. The first fixed terminal 6 and the second fixed terminal 7 are comprised of conductive material such as copper.

The first fixed terminal 6 includes a first contact support portion 6a and a first external connection portion 6b. The first contact support portion 6a is disposed within the contact case 2. The first contact support portion 6a extends in a direction perpendicular to the up-down direction. The first external connection portion 6b protrudes upward from the top wall 2a of the contact case 2 and is exposed to the exterior of the contact case 2.

The second fixed terminal 7 is spaced apart from the first fixed terminal 6 in the left-right direction. The second fixed terminal 7 is arranged to the right of the first fixed terminal 6. The second fixed terminal 7 includes a second contact support portion 7a and a second external connection portion 7b. The second contact support portion 7a is disposed within contact case 2. The second contact support portion 7a extends in a direction perpendicular to the up-down direction. The second external connection portion 7b protrudes upward from the top wall 2a of the contact case 2 and is exposed to the exterior of the contact case 2.

The first fixed contact 8 is comprised of conductive material such as copper. The first fixed contact 8 is connected to the first fixed terminal 6. The first fixed contact 8 is supported by the first contact support portion 6a. The first fixed contact 8 protrudes downward from the lower surface of the first contact support portion 6a.

The second fixed contact 9 is comprised of conductive material such as copper. The second fixed contact 9 is connected to the second fixed terminal 7. The second fixed contact 9 is supported by the second contact support portion 7a. The second fixed contact 9 protrudes downward from the lower surface of the second contact support portion 7a.

The movable contact piece 10 is a plate member that is elongated in one direction and extends in the left-right direction within the contact case 2. In the present embodiment, the longitudinal direction of movable contact piece 10 coincides with the left-right direction. The transverse direction of movable contact piece 10 coincides with the front-rear direction. The movable contact piece 10 is comprised of conductive material such as copper. The side wall 2c of the contact case 2 is disposed to a side of the movable contact piece 10.

The movable contact piece 10 is arranged to be movable in a contact direction Z1 (here, the upward direction) in which the first movable contact 11 approaches the first fixed contact 8 and the second movable contact 12 approaches the second fixed contact 9, and in a separation direction Z2 (here, the downward direction) in which the first movable contact 11 separates from the first fixed contact 8 and the second movable contact 12 separates from the second fixed contact 9. That is, in the present embodiment, the movable contact piece 10 is arranged to be movable in the up-down direction.

The movable contact piece 10 includes a first surface 10a facing the first fixed contact 8 and the second fixed contact 9 in the up-down direction, and a second surface 10b that is on the opposite side of the movable contact piece 10 (in terms of the up-down direction) than the first surface 10a. The first surface 10a and the second surface 10b extend in a direction perpendicular to the up-down direction. The first surface 10a is arranged below the first fixed contact 8 and the second fixed contact 9. The first surface 10a faces the top wall 2a of the contact case 2 in the up-down direction. The first surface 10a faces the first fixed contact 8 and the second fixed contact 9 in the up-down direction. The first surface 10a is the upper surface of the movable contact piece 10, and the second surface 10b is the lower surface of the movable contact piece 10. The second surface 10b faces the bottom wall 2b of the contact case 2 in the up-down direction.

The movable contact piece 10 includes a through-hole 10c. The through-hole 10c is formed at the center of the movable contact piece 10. The through-hole 10c has a hole shape that penetrates in the up-down direction.

The first movable contact 11 is connected to the movable contact piece 10. The first movable contact 11 is arranged on the first surface 10a of the movable contact piece 10 and faces the first fixed contact 8 in the up-down direction. The first movable contact 11 is arranged below the first fixed contact 8. The first movable contact 11 protrudes upward from the first surface 10a of the movable contact piece 10. The first movable contact 11 is configured to contact the first fixed contact 8 in accordance with the movement of the movable contact piece 10. The first movable contact 11 is comprised of conductive material such as copper.

The second movable contact 12 is connected to the movable contact piece 10. The second movable contact 12 is arranged on the first surface 10a of the movable contact piece 10 and faces the second fixed contact 9 in the up-down direction. The second movable contact 12 is arranged below the second fixed contact 9. The second movable contact 12 protrudes upward from the first surface 10a of the movable contact piece 10. The second movable contact 12 is configured to contact the second fixed contact 9 in accordance with the movement of the movable contact piece 10. The second movable contact 12 is comprised of conductive material such as copper.

The movable mechanism 13 supports the movable contact piece 10. The movable mechanism 13 includes a drive shaft 21, a first holding member 22, a second holding member 23, and a contact spring 24.

The drive shaft 21 is a shaft member that passes through the through-hole 10c of the movable contact piece 10 in the up-down direction. The drive shaft 21 extends parallel to the up-down direction. The drive shaft 21 is set to be movable in the up-down direction. The drive shaft 21 is connected to the movable contact piece 10 so as to be relatively movable at the center of the movable contact piece 10 in the left-right direction and the front-rear direction.

The first holding member 22 is fixed to the drive shaft 21 above the movable contact piece 10. The second holding member 23 is fixed to the drive shaft 21 below the movable contact piece 10. The contact spring 24 is arranged between the movable contact piece 10 and the second holding member 23 in a compressed state. The contact spring 24 is a coil spring, and the drive shaft 21 extends through the center of the contact spring 24. The contact spring 24 urges the movable contact piece 10 in the contact direction Z1.

The drive device 4 is arranged below the contact device 3. The drive device 4 uses electromagnetic force to move the movable contact piece 10 in the up-down direction via the drive shaft 21 of the movable mechanism 13. The drive device 4 includes a coil 31, a movable iron core 32, a fixed iron core 33, a yoke 34, and a return spring 35.

When energized by application of a voltage, the coil 31 generates an electromagnetic force that moves the movable iron core 32 in the contact direction Z1. The movable iron core 32 is connected to the drive shaft 21 so as to be integrally movable with the drive shaft 21. The fixed iron core 33 is arranged at a position facing the movable iron core 32. The yoke 34 is arranged to surround the coil 31. The return spring 35 is arranged between the movable iron core 32 and the fixed iron core 33. The return spring 35 urges the movable iron core 32 in the separation direction Z2.

FIG. 1 shows a state in which the drive device 4 is not energized. While the drive device 4 is not energized, the first movable contact 11 is separated from the first fixed contact 8, and the second movable contact 12 is separated from the second fixed contact 9.

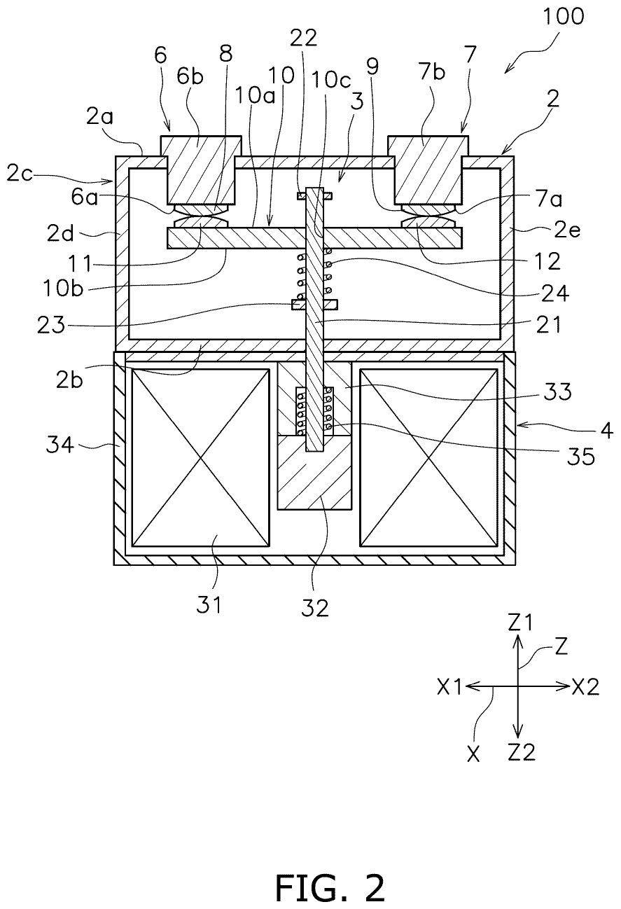

FIG. 2 shows a state when the drive device 4 is energized and the movable mechanism 13 has moved in the contact direction Z1. When the drive device 4 is energized, the movable iron core 32 moves together with the drive shaft 21 in the contact direction Z1.

As the drive shaft 21 moves in the contact direction Z1, the contact spring 24 is compressed by the second holding member 23. As a result, the force pressing the movable contact piece 10 in the contact direction Z1 increases, the movable contact piece 10 moves in the contact direction Z1, the first movable contact 11 comes in contact with the first fixed contact 8, and the second movable contact 12 comes in contact with the second fixed contact 9. Hereinafter, the state in which the first movable contact 11 is in contact with the first fixed contact 8 and the second movable contact 12 is in contact with the second fixed contact 9 will be referred to as a closed state. In the closed state, the first holding member 22 is separated from the movable contact piece 10 in the up-down direction.

FIG. 4 is a diagram illustrating the flow of a first airflow in the vicinity of the first fixed contact 8 and the first movable contact 11, wherein the airflow is generated due to a current flowing between the first fixed contact 8 and the first movable contact 11. FIG. 4 is a schematic cross-sectional diagram of the movable contact piece 10 and surrounding portions taken along a plane orthogonal to the front-rear direction. The guide wall 5 is arranged inside the contact case 2. The guide wall 5 is connected to the inner surface of the contact case 2. In the present embodiment, the guide wall 5 is integral with the contact case 2 and is configured by a single member together with the contact case 2. It should be noted that FIG. 4 and subsequent drawings do not illustrate the movable mechanism 13.

The guide wall 5 guides the first airflow toward the second surface 10b of the movable contact piece 10. The guide wall 5 includes a first guide surface 41, a second guide surface 42, and a third guide surface 43. The first to third guide surfaces 41 to 43 lead the air in the first airflow, which is flowing toward the left side wall 2d, toward the second surface 10b of the movable contact piece 10. In FIG. 4, arrows schematically indicate the flow of the first airflow flowing toward the left side wall 2d. It should be noted that FIGS. 1 and 2 do not illustrate the guide wall 5.

The first airflow occurs due to melting or scattering of the first fixed contact 8 and first movable contact 11, an arc generated between the first fixed contact 8 and the first movable contact 11, and the like. The first airflow also occurs due to an increase in pressure that is caused by an increase in the temperature of the air in the vicinity of the first fixed contact 8 and the first movable contact 11.

The first to third guide surfaces 41 to 43 are slanted with respect to the second surface 10b of the movable contact piece 10 in a cross-sectional view perpendicular to the front-rear direction. The first to third guide surfaces 41 to 43 are arranged to the left of the center of the movable contact piece 10 in the left-right direction.

The first guide surface 41 is arranged to the left of the movable contact piece 10 within the contact case 2. The first guide surface 41 is arranged at a position overlapping the movable contact piece 10 in the left-right direction. The first guide surface 41 extends in the front-rear direction. The first guide surface 41 is connected to the left side wall 2d and the bottom wall 2b. The first guide surface 41 extends from the inner surface of the left side wall 2d in the left-right direction and in the separation direction Z2. The first guide surface 41 extends from the inner surface of the left side wall 2d, toward the underside of the movable contact piece 10, to the bottom wall 2b.

The first guide surface 41 has an upper end that is connected to the left side wall 2d. The upper end of the first guide surface 41 is located above the movable contact piece 10 when it is in the closed state. The lower end of the first guide surface 41 is connected to the bottom wall 2b. The lower end of the first guide surface 41 is located approximately under the left end of the movable contact piece 10. The upper end of the first guide surface 41 is located to the left of the lower end, and the first guide surface 41 extends from the upper end toward the lower end in a direction approaching the center of the movable contact piece 10 in the left-right direction. The front end of the first guide surface 41 is connected to the front wall 2f. The rear end of the first guide surface 41 is connected to the rear side wall 2g.

The first airflow, after hitting the first guide surface 41, is guided toward the underside of the movable contact piece 10 by the first guide surface 41 and then led to the second surface 10b of the movable contact piece 10.

The second guide surface 42 is arranged below the movable contact piece 10 within the contact case 2. The second guide surface 42 is arranged at a position overlapping the second surface 10b of the movable contact piece 10 in the up-down direction. The second guide surface 42 is arranged at a position overlapping the first movable contact 11 of the movable contact piece 10 in the up-down direction. The second guide surface 42 is separated from the first guide surface 41 in the left-right direction. The second guide surface 42 is arranged to the right of the first guide surface 41 and faces the first guide surface 41 in the left-right direction. The second guide surface 42 extends in the front-rear direction.

The second guide surface 42 extends from the bottom wall 2b of the contact case 2 toward the second surface 10b of the movable contact piece 10. The second guide surface 42 faces the second surface 10b of the movable contact piece 10 in the up-down direction.

The second guide surface 42 has a lower end connected to the bottom wall 2b. The second guide surface 42 has an upper end located to the right of the lower end and extends from the lower end toward the upper end in a direction approaching the center of the movable contact piece 10 in the left-right direction. The front end of the second guide surface 42 is connected to the front wall 2f. The rear end of the second guide surface 42 is connected to the rear side wall 2g.

The second guide surface 42 is configured to push up the first airflow, which has been guided below the movable contact piece 10 by the first guide surface 41, toward the second surface 10b of the movable contact piece 10. That is, the first airflow guided below the movable contact piece 10 by the first guide surface 41 is easily led to the second surface 10b of the movable contact piece 10 by the second guide surface 42.

The third guide surface 43 is arranged to the left of the first fixed terminal 6 within the contact case 2. The third guide surface 43 is arranged above the first guide surface 41 and faces the first guide surface 41 in the up-down direction. The third guide surface 43 extends in the left-right direction from the inner surface of the left side wall 2d toward the first fixed terminal 6. The third guide surface 43 extends from the inner surface of the left side wall 2d in the left-right direction and in the contact direction Z1 and is slanted with respect to the second surface 10b of the movable contact piece 10. The third guide surface 43 is connected to the left side wall 2d and the top wall 2a. The third guide surface 43 extends in the front-rear direction.

The third guide surface 43 has an upper end connected to the top wall 2a. The lower end of the third guide surface 43 is connected to the left side wall 2d. The lower end of the third guide surface 43 is located approximately to the left of the lower end of the first fixed contact 8. The upper end of the third guide surface 43 is disposed to the right of the lower end, and the third guide surface 43 extends from the lower end toward the upper end in a direction approaching the center of the movable contact piece 10 in the left-right direction. The front end of the third guide surface 43 is connected to the front wall 2f. The rear end of the third guide surface 43 is connected to the rear side wall 2g.

The third guide surface 43 guides the first airflow, which flows toward the left side wall 2d, toward the first guide surface 41. That is, the first airflow that has hit the third guide surface 43 flows toward the first guide surface 41. As a result, the first airflow, after hitting the third guide surface 43, is guided toward the underside of the movable contact piece 10 by the first guide surface 41 and led to the second surface 10b of the movable contact piece 10.

The guide wall 5 further includes a first guide surface 51, a second guide surface 52, and a third guide surface 53. The first to third guide surfaces 51 to 53 lead a second airflow in the vicinity of the second fixed contact 9 and the second movable contact 12 toward the second surface 10b of contact piece 10, wherein the second airflow occurs due to a current flowing between the second fixed contact 9 and the second movable contact 12. More specifically, the first to third guide surfaces 51 to 53 lead the air, which flows toward the right wall 2e in the second airflow, toward the second surface 10b of the movable contact piece 10.

The first to third guide surfaces 51 to 53 are bilaterally symmetric to the first guide surfaces 41 to 43 with respect to the drive shaft 21. Therefore, no detailed description of the first guide surfaces 51 to 53 will be provided here.

In the electromagnetic relay 100 of the above-described embodiment, for example, the first airflow that occurs due to a short circuit current flowing between the first fixed contact 8 and the first movable contact 11 is led to the second surface 10b of the movable contact piece 10 by the first to third guide surfaces 41 to 43 of the guide wall 5. As a result, the movable contact piece 10 is pressed in the contact direction Z1 by the first airflow that has been led to the second surface 10b. With this configuration, the contact force of the first movable contact 11 to the first fixed contact 8 can be increased. That is, the contact force of the contact can be increased in the case where at least one of the first fixed contact 8 and the first movable contact 11 melts and scatters.

Further, for example, the second airflow that occurs due to a short circuit current flowing between the second fixed contact 9 and the second movable contact 12 is led to the second surface 10b of the movable contact piece 10 by the first to third guide surfaces 51 to 53. As a result, the movable contact piece 10 is pressed in the contact direction Z1 by the second airflow that has been led to the second surface 10b. With this configuration, the contact force of the second movable contact 12 to the second fixed contact 9 can be increased.

It should be noted that, in the present embodiment, the separation speed of the contacts may be reduced by the first airflow and the second airflow during a normal shutoff (at a transition from the closed state to the open state), and thereby, a structure is preferably mounted that is configured to allow the first airflow and the second airflow to escape, such as a flow path that opens and closes in accordance with the movement of the movable mechanism 13, and/or a space created by the movement of the movable iron core 32 at the timing of shutoff. One embodiment of the electromagnetic relay according to one aspect of the claimed invention has been described above. The claimed invention, however, is not limited to the above embodiment, and various changes can be made without departing from the scope of the claimed invention.

In the drawings described below, the same components as in the above-described embodiment are given the same reference numerals as in the above-described embodiment.

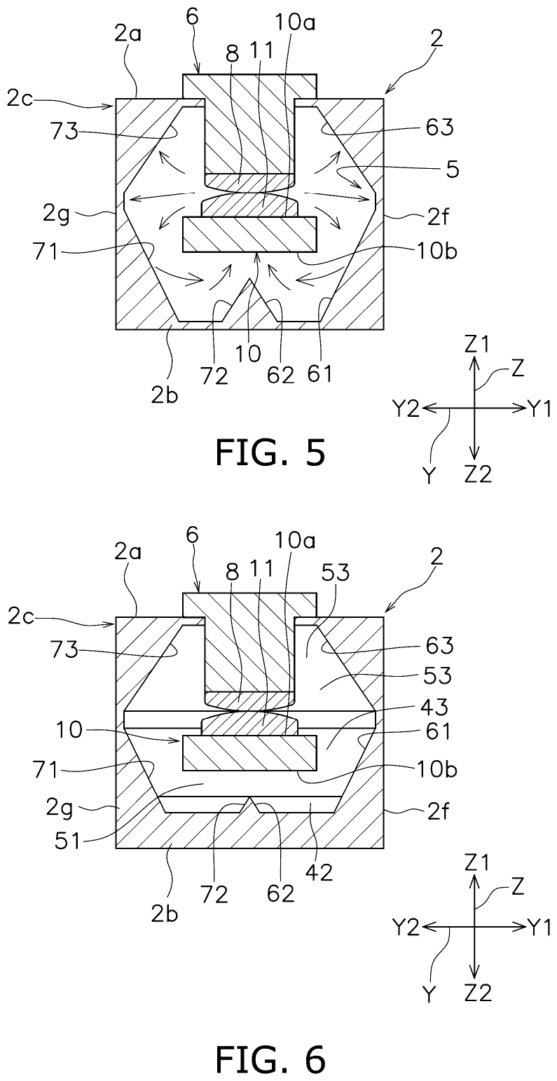

FIG. 5 is a schematic cross-sectional diagram of the first fixed contact 8 and surrounding portions of the electromagnetic relay 100 according to a first modification, taken along a plane orthogonal to the left-right direction, as seen from the left side. In FIG. 5, the flow of the first airflow toward the front wall 2f and the rear side wall 2g is indicated schematically by arrows.

The guide wall 5 of the electromagnetic relay 100 according to the first modification includes fourth guide surfaces 61, 71, fifth guide surfaces 62, 72, and sixth guide surfaces 63, 73. It should be noted that the guide wall 5 of the electromagnetic relay 100 according to the first modification does not include the first guide surfaces 41, 51, the second guide surfaces 42, 52, and the third guide surfaces 43, 53.

The fourth to sixth guide surfaces 61 to 63 lead the air, which flows toward the front wall 2f in the first airflow, toward the second surface 10b of the movable contact piece 10. The fourth to sixth guide surfaces 61 to 63 are slanted with respect to the second surface 10b of the movable contact piece 10 in a cross-sectional view perpendicular to the left-right direction. The fourth to sixth guide surfaces 61 to 63 are arranged in front of the center of the movable contact piece 10 in the front-rear direction.

The fourth guide surface 61 is arranged in front of the movable contact piece 10 within the contact case 2. The fourth guide surface 61 is arranged at a position overlapping the movable contact piece 10 in the front-back direction. The fourth guide surface 61 extends in the left-right direction. The fourth guide surface 61 is connected to the front wall 2f and the bottom wall 2b. The fourth guide surface 61 extends from the inner surface of the front wall 2f in the front-rear direction and the separation direction Z2. The fourth guide surface 61 extends from the inner surface of the front wall 2f, toward the underside of the movable contact piece 10, to the bottom wall 2b.

The upper end of the fourth guide surface 61 is connected to the front wall 2f. The upper end of the fourth guide surface 61 is located above the movable contact piece 10 in the closed state. The lower end of the fourth guide surface 61 is connected to the bottom wall 2b. The lower end of the fourth guide surface 61 is located approximately under the front end of the movable contact piece 10. The upper end of the fourth guide surface 61 is located to the front of the lower end, and the fourth guide surface 61 extends from the upper end toward the lower end in a direction approaching the center of the movable contact piece 10 in the front-rear direction. The left end of the fourth guide surface 61 is connected to the left side wall 2d. The right end of the fourth guide surface 61 is connected to the right wall 2e.

The fifth guide surface 62 is configured to push up the first airflow, which has been guided toward the underside of the movable contact piece 10 by the fourth guide surface 61, toward the second surface 10b of the movable contact piece 10. The fifth guide surface 62 is arranged below the movable contact piece 10 within the contact case 2. The fifth guide surface 62 is arranged at a position overlapping the second surface 10b of the movable contact piece 10 in the up-down direction. The fifth guide surface 62 is arranged at a position overlapping the first movable contact 11 of the movable contact piece 10 in the up-down direction. The fifth guide surface 62 is separated from the fourth guide surface 61 in the front-back direction. The fifth guide surface 62 is arranged behind the fourth guide surface 61 and faces the fourth guide surface 61 in the front-rear direction. The fifth guide surface 62 extends in the left-right direction except for the portion where the drive shaft 21 is arranged. That is, the fifth guide surface 62 is also arranged at a position overlapping the second movable contact 12 in the up-down direction.

The fifth guide surface 62 extends from the inner surface of the bottom wall 2b toward the second surface 10b of the movable contact piece 10. The fifth guide surface 62 faces the second surface 10b of the movable contact piece 10 in the up-down direction. The lower end of the fifth guide surface 62 is connected to the bottom wall 2b. The upper end of the fifth guide surface 62 is disposed to the left of the lower end, and the fifth guide surface 62 extends from the lower end toward the upper end in a direction approaching the center of the movable contact piece 10 in the front-rear direction.

The sixth guide surface 63 guides the first airflow, which flows toward the front wall 2f, toward the fourth guide surface 61. The sixth guide surface 63 is arranged, within the contact case 2, to the front of the first fixed terminal 6. The sixth guide surface 63 extends in the left-right direction. The sixth guide surface 63 is connected to the front wall 2f and the top wall 2a. The sixth guide surface 63 extends from the inner surface of the front wall 2f toward the first fixed terminal 6 in the front-rear direction. The sixth guide surface 63 extends from the inner surface of the front wall 2f in the front-rear direction and in the contact direction Z1.

The upper end of the sixth guide surface 63 is connected to the top wall 2a. The lower end of the sixth guide surface 63 is connected to the front wall 2f. The lower end of the sixth guide surface 63 is arranged approximately to the front of the lower end of the first fixed contact 8. The upper end of the sixth guide surface 63 is disposed to the rear of the lower end, and the sixth guide surface 63 extends from the lower end toward the upper end in a direction approaching the center of the movable contact piece 10 in the front-rear direction. The left end of the sixth guide surface 63 is connected to the left side wall 2d. The right end of the sixth guide surface 63 is connected to the right wall 2e.

The fourth to sixth guide surfaces 71 to 73 lead the air, which flows toward the rear side wall 2g in the first airflow, toward the second surface 10b of the movable contact piece 10. The fourth to sixth guide surfaces 71 to 73 have a front-back symmetrical shape with the fourth to sixth guide surfaces 61 to 63. Therefore, no detailed explanation of the fourth to sixth guide surfaces 71 to 73 will be provided here.

In the electromagnetic relay 100 according to the first modification, the first airflow is led to the second surface 10b of the movable contact piece 10 by the fourth guide surfaces 61, 71, the fifth guide surfaces 62, 72, and the sixth guide surfaces 63, 73. With this configuration, the contact force of the first movable contact 11 to the first fixed contact 8 can be increased. In addition, the second airflow is led to the second surface 10b of the movable contact piece 10 by the fourth guide surfaces 61, 71, the fifth guide surfaces 62, 72, and the sixth guide surfaces 63, 73. With this configuration, the contact force of the second movable contact 12 to the second fixed contact 9 can be increased.

FIG. 6 is a schematic cross-sectional diagram of the first fixed contact 8 and surrounding portions of the electromagnetic relay 100 according to a second modification, taken along a plane orthogonal to the left-right direction, as seen from the left side. The guide wall 5 of the electromagnetic relay 100 according to the second modification is composed of a combination of the guide wall 5 according to the first embodiment and the guide wall 5 according to the first modification. That is, the guide wall 5 of the electromagnetic relay 100 according to the second modification includes the first guide surfaces 41, 51, the second guide surfaces 42, 52, the third guide surfaces 43, 53, the fourth guide surfaces 61, 71, and the fifth guide surfaces 62, 72, and the sixth guide surfaces 63, 73.

In the guide wall 5 of the electromagnetic relay 100 according to the second modification, the fifth guide surfaces 62, 72 may be omitted. Alternatively, the second guide surfaces 42, 52 may be omitted. That is, the combination of the first guide surfaces 41, 51, the second guide surfaces 42, 52, the third guide surfaces 43, 53, the fourth guide surfaces 61, 71, the fifth guide surfaces 62, 72, and the sixth guide surfaces 63 and 73 may be changed as appropriate.

For example, in the first embodiment, the second guide surfaces 42, 52 may be omitted. In the first embodiment, the guide wall 5 only has at least one of the first guide surface 41 and the third guide surface 43. In the guide wall 5 according to the first modification, the fifth guide surfaces 62, 72 may be omitted, and the guide wall 5 only has at least one of the fourth guide surface 61 and the sixth guide surface 63.

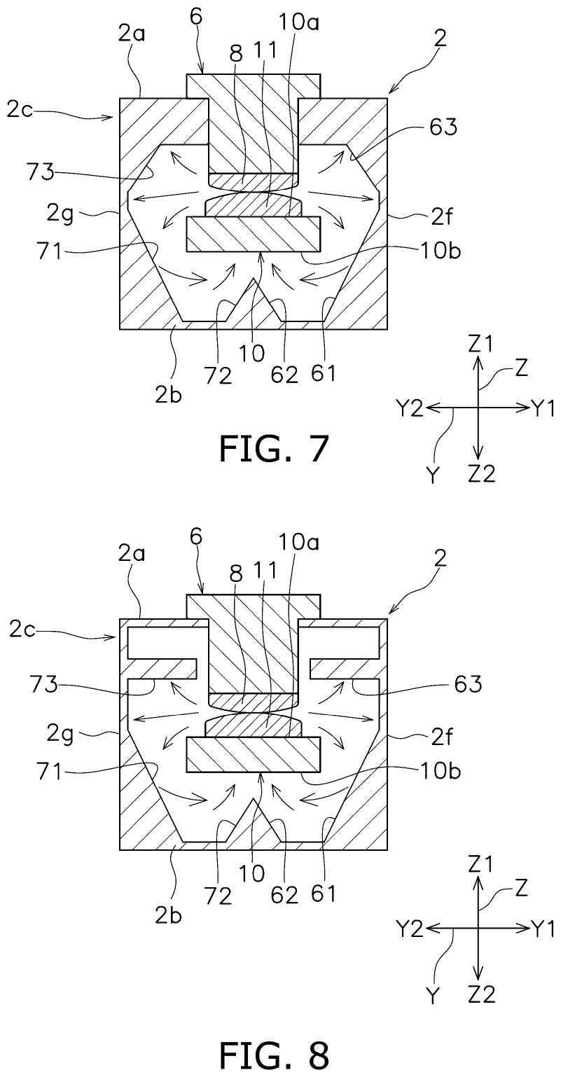

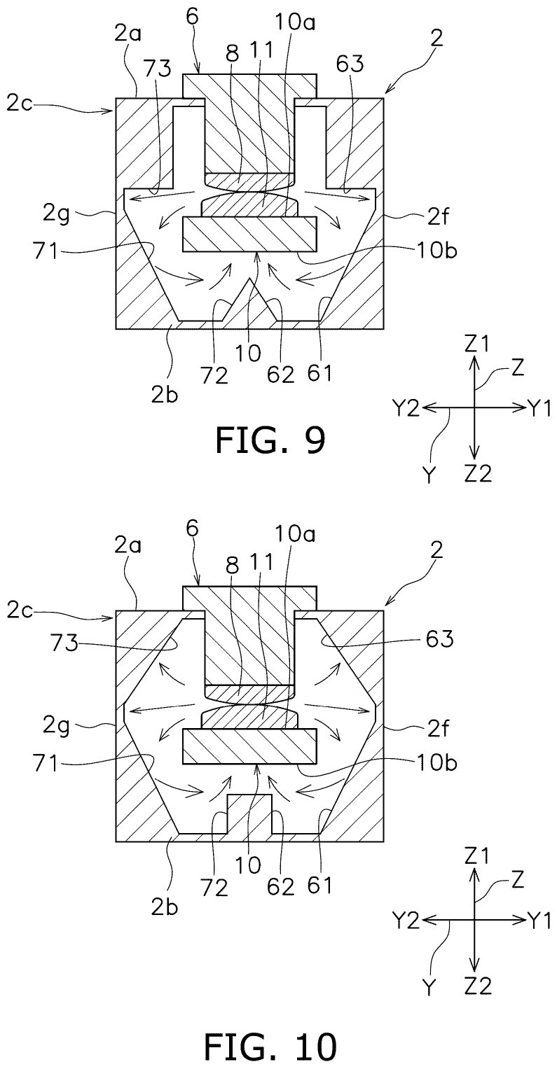

The shapes of the third guide surfaces 43, 53 and the sixth guide surfaces 63, 73 may be changed. For example, the third guide surfaces 43, 53 and the sixth guide surfaces 63, 73 may have shapes that narrow the spaces to a side of the first fixed terminal 6 and the second fixed terminal 7 in the contact case 2. For example, as shown in FIG. 7, the third guide surfaces 43, 53 and the sixth guide surfaces 63, 73 may have thickness in the up-down direction. Alternatively, as shown in FIG. 8, the third guide surfaces 43, 53 and the sixth guide surfaces 63, 73 may be configured as planes perpendicular to the up-down direction. In addition, as shown in FIG. 9, the third guide surfaces 43, 53 and the sixth guide surfaces 63, 73 may be each configured by a step portion protruding from the side wall 2c toward the first fixed terminal 6 and the second fixed terminal 7 within the contact case 2.

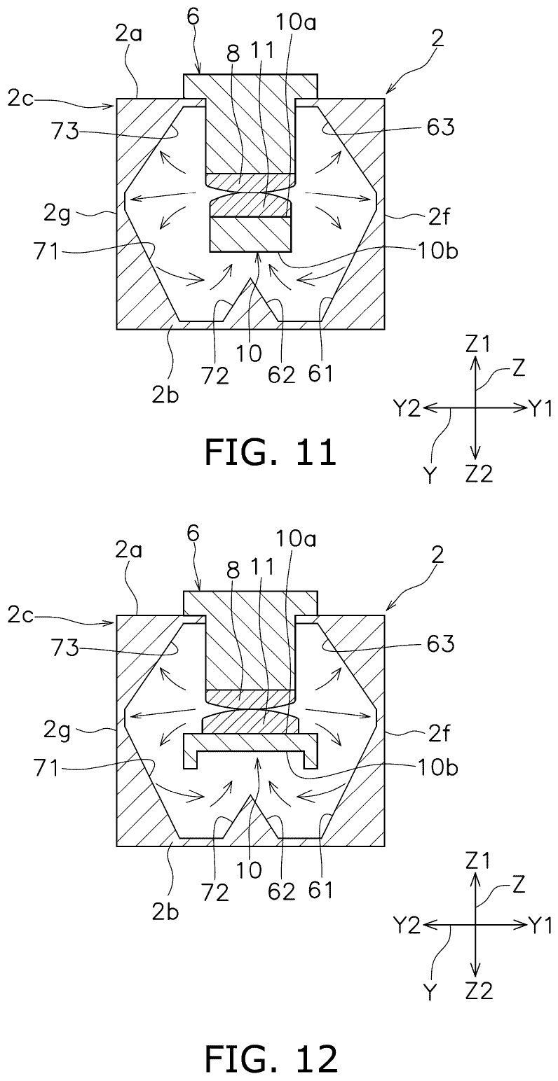

The shapes of the second guide surfaces 42, 52 and the fifth guide surfaces 62, 72 may be changed. For example, as shown in FIG. 10, the fifth guide surfaces 62, 72 may be configured as planes perpendicular to the front-rear direction. Similarly, the second guide surfaces 42, 52 may be configured as planes perpendicular to the left-right direction. The shape of the movable contact piece 10 may be changed. As shown in FIG. 11, the front-rear dimension of the movable contact piece 10 may be smaller than the front-rear dimension of the first fixed terminal 6 in the contact case 2. Alternatively, as shown in FIG. 4, the dimension of the movable contact piece 10 in the left-right direction may be smaller than the distance from the left end of the first fixed terminal 6 to the right end of the second fixed terminal 7. In this case, the first airflow and the second airflow are easily guided to the second surface 10b of the movable contact piece 10.

As shown in FIG. 12, the movable contact piece 10 may have a concave shape (concave portion) that is recessed upward on the second surface 10b. The concave portion of the movable contact piece 10 is located at a position overlapping at least the first movable contact 11 and the second movable contact 12 in the up-down direction.

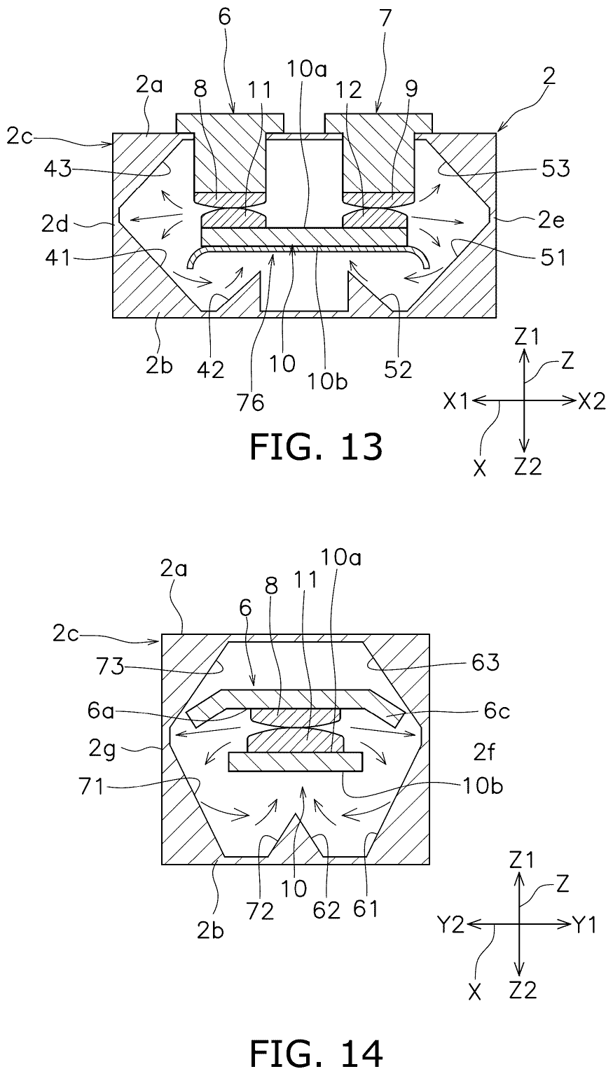

As shown in FIG. 13, the electromagnetic relay 100 may further include an interlocking member 76 configured to move in conjunction with the movable contact piece 10. The interlocking member 76 is arranged on the second surface 10b of the movable contact piece 10. The interlocking member 76 has a shape that is recessed toward the second surface 10b of the movable contact piece 10. That is, the lower surface of the interlocking member 76 has a shape (concavity) that is recessed upward. In this case, for example, the first airflow may press the movable contact piece 10 in the contact direction Z1 via the interlocking member 76. That is, a configuration is possible in which the first airflow and the second airflow led toward the second surface 10b of the movable contact piece 10 by the guide wall 5 indirectly press the movable contact piece 10 in the contact direction Z1. Alternatively, the guide wall 5 may be configured such that, in addition to the second surface 10b of the movable contact piece 10, the second holding member 23 disposed below the movable contact piece 10 and a member such as a holder for holding the movable contact piece 10 are pressed by the first airflow and the second airflow in the contact direction Z1.

The first fixed terminal 6 and the second fixed terminal 7 may be plate terminals. In that case, for example, as shown in FIG. 14, extension portion 6c extending in the front-rear direction from both ends of the first contact support portion 6a in the front-back direction may be included. The extension portion 6c extends from the first contact support portion 6a toward the side wall 2c in a direction approaching the movable contact piece 10. It should be noted that the extension portion 6c may be formed at the left end of the first contact support portion 6a.

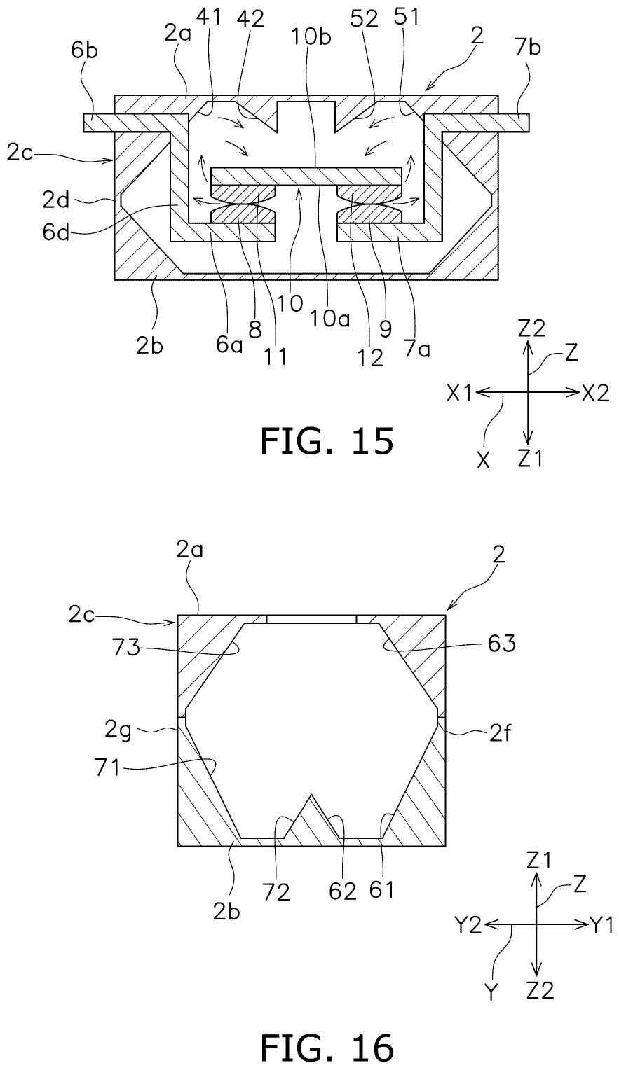

The first fixed terminal 6 and the second fixed terminal 7 may have a bent shape. For example, as shown in FIG. 15, the first fixed terminal 6 may include a longitudinal portion 6d. The longitudinal portion 6d is disposed to a side of the movable contact piece 10. The longitudinal portion 6d extends from the first contact support portion 6a toward the first guide surface 41. The longitudinal portion 6d extends upward within the contact case 2 from the left end of the first contact support portion 6a. The longitudinal portion 6d is configured to lead the first airflow toward the second surface 10b of the movable contact piece 10. In the example shown in FIG. 15, the first guide surface 41 and the second guide surface 42 are arranged on the top wall 2a. The longitudinal portion 6d is connected to the first guide surface 41.

The contact case 2 may be formed by combining multiple members. For example, as shown in FIG. 16, the contact case 2 may be configured by combining a plurality of divided members. For example, the contact case 2 may be configured by combining members that are divided in the up-down direction. Alternatively, the contact case 2 may be composed of components that are divided in the left-right direction or the front-rear direction.

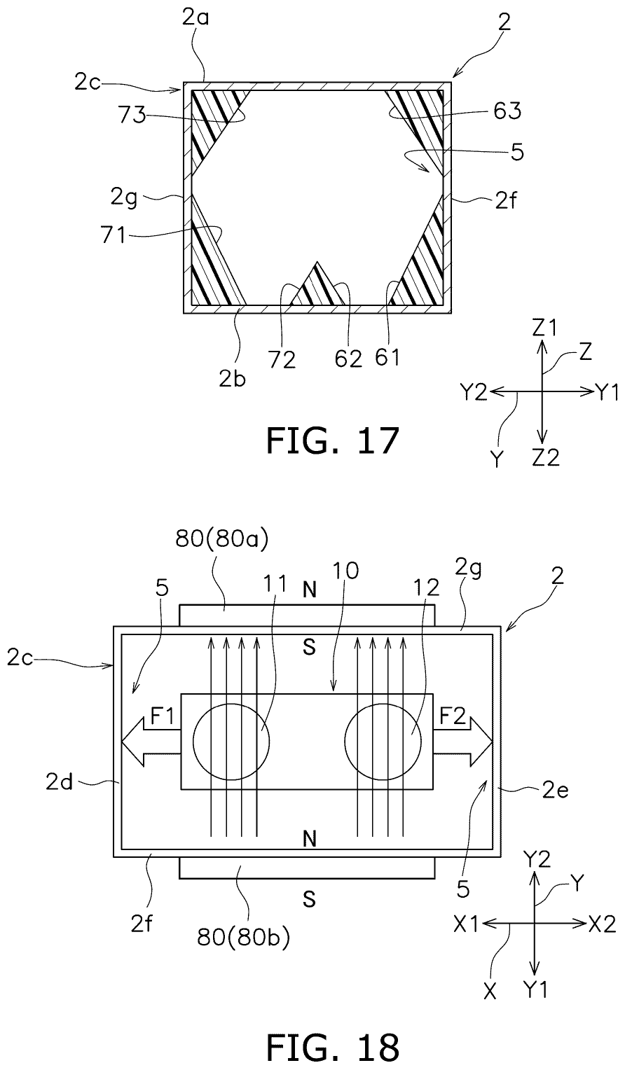

As shown in FIG. 17, the guide wall 5 may be a separate member from the contact case 2. The contact case 2 and the guide wall 5 may be formed of different materials. For example, the contact case 2 may be comprised of ceramic or metal, and the guide wall 5 may be comprised of resin.

In the above embodiment, the contact case 2 has a rectangular shape when viewed from above. The contact case 2, however, may have a circular or elliptical shape when viewed from above.

The electromagnetic relay 100 according to the first embodiment may further include a magnet section 80, as shown in FIG. 18. The magnet section 80 generates a magnetic field for extending a first arc that occurs between the first fixed contact 8 and the first movable contact 11 and a second arc that occurs between the second fixed contact 9 and the second movable contact 12. The magnet section 80 is arranged on the outer surface of the side wall 2c of the contact case 2. The magnet section 80 includes a first magnet 80a and a second magnet 80b. The first magnet 80a and the second magnet 80b are, for example, permanent magnets. The first magnet 80a and the second magnet 80b are arranged such that their different polarities face each other in the front-rear direction. In the embodiment shown in FIG. 17, the North pole of the first magnet 80a faces the front wall 2f. The South pole of the second magnet 80b faces the rear side wall 2g.

When a current flows from the first movable contact 11 toward the first fixed contact 8, a Lorentz force F1 acts on the first arc in a direction toward the left side wall 2d. That is, the first arc is extended in a direction toward the first guide surface 41 and the third guide surface 43. The first guide surface 41 and the third guide surface 43 are located in the direction in which the first arc is extended, which thereby enables effective control of the flow of the first airflow. Further, a Lorentz force F2 acts on the second arc in the direction toward the right wall 2e, and thereby the flow of the second airflow can be effectively controlled by the first guide surface 51 and the third guide surface 53. It should be noted that the electromagnetic relay 100 according to the second modification may further include the magnet section 80.

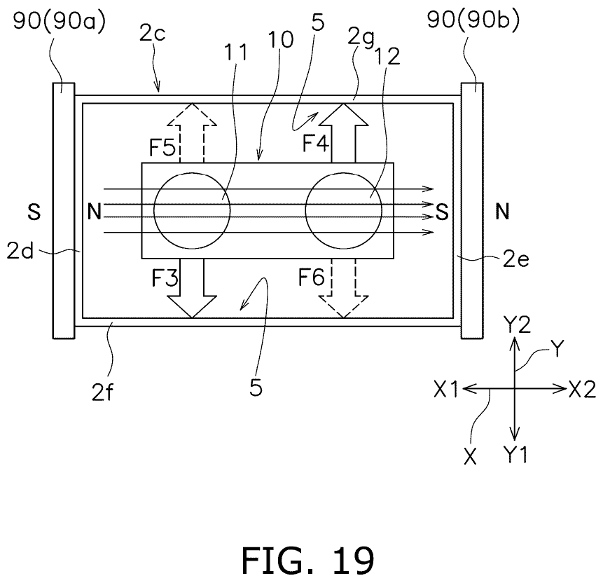

The electromagnetic relay 100 according to the first modification may further include a magnet section 90, as shown in FIG. 19. The magnet section 90 generates a magnetic field for extending the first are and the second arc. The magnet section 90 is arranged such that a Lorentz force acts on the first arc and the second are in the lateral direction of the movable contact piece 10. The magnet section 90 is arranged on the outer surface of the side wall 2c of the contact case 2. The magnet section 90 includes a first magnet 90a and a second magnet 90b. The first magnet 90a and the second magnet 90b are, for example, permanent magnets. The first magnet 90a and the second magnet 90b are arranged such that their different polarities face each other in the left-right direction. In the embodiment shown in FIG. 18, the North pole of the first magnet 90a faces the left side wall 2d. The South pole of the second magnet 90b faces the right wall 2e.

When a current flows from the first fixed contact 8 toward the first movable contact 11, a Lorentz force F3 acts on the first arc in a direction toward the front wall 2f. That is, the first arc is extended in the direction toward the fourth guide surface 61 and the sixth guide surface 63. A Lorentz force F4 acts on the second arc in the direction toward the rear side wall 2g. That is, the second arc is extended in the direction toward the fourth guide surface 71 and the sixth guide surface 73. In the case where the current flows in the opposite direction (flowing from the first movable contact 11 to the first fixed contact 8), a Lorentz force F5 acts on the first arc in the direction toward the rear side wall 2g, and a Lorentz force F6 acts on the second arc in a direction toward the front wall 2f. It should be noted that the first magnet 90a and the second magnet 90b may be arranged such that the same polarities face each other in the left-right direction. The electromagnetic relay 100 according to the second modification may also further include the magnet section 90.

The first fixed contact 8 and the first movable contact 11 may be comprised of different materials. The second fixed contact 9 and the second movable contact 12 may be comprised of different materials. The first movable contact 11 and the second movable contact 12 may be embedded in the movable contact piece 10. That is, the first movable contact 11 and the second movable contact 12 do not need to protrude upward from the movable contact piece 10. In the case where the first movable contact 11 and the second movable contact 12 protrude upward from the movable contact piece 10, the first fixed contact 8 may be embedded in the first contact support portion 6a of the first fixed terminal 6, and the second fixed contact 9 may be embedded in the second contact support portion 7a of the second fixed terminal 7.

### REFERENCE NUMERALS

2: Contact case, 2a: Top wall (Example of first outer wall), 2b: Bottom wall (Example of second outer wall), 2c: Side wall (Example of third outer wall), 4: Drive device, 5: Guide wall, 6: First fixed terminal, 7: Second fixed terminal, 8: First fixed contact, 9: Second fixed contact, 11: First movable contact, 12: Second movable contact, 21: Drive shaft, 24: Contact spring, 41: First guide surface, 42: Second guide surface, 43: Third guide surface, 61: Fourth guide surface, 62: Fifth guide surface, 63: Sixth guide surface, 100: Electromagnetic relay, X: First direction, Z: Second direction, Z1: Contact direction, Z2: Separation direction, Y: Third direction

1. An electromagnetic relay, comprising:
a first fixed terminal;
a first fixed contact connected to the first fixed terminal;
a second fixed terminal;
a second fixed contact connected to the second fixed terminal, the second fixed contact being disposed apart from the first fixed contact in a first direction;
a movable contact piece including a first surface on one side thereof that faces the first fixed contact and the second fixed contact, and a second surface on an opposite side of the movable contact piece;
a first movable contact disposed on the first surface of the movable contact piece, the first movable contact facing the first fixed contact in a second direction, the second direction including a contact direction toward the first fixed contact and a separation direction away from the first fixed contact;
a second movable contact disposed on the first surface of the movable contact piece, the second movable contact facing the second fixed contact;
a drive shaft connected to the movable contact piece;
a drive device configured to move the movable contact piece in the second direction via the drive shaft;
a contact case including a first outer wall facing the first surface of the movable contact piece, a second outer wall facing the second surface of the movable contact piece, and a third outer wall disposed to a side of the movable contact piece, the third outer wall connected to the first outer wall and the second outer wall, the contact case accommodating the first fixed contact, the second fixed contact, the first movable contact, the second movable contact, and the movable contact piece; and
a guide wall connected to an inner surface of the contact case, the guide wall being configured to lead a first airflow in vicinities of the first fixed contact and the first movable contact toward the second surface of the movable contact piece, wherein the first airflow occurs due to a current that flows between the first fixed contact and the first movable contact.

2. The electromagnetic relay according to claim 1, wherein the guide wall includes a first guide surface, the first guide surface being disposed to a side of the movable contact piece, the first guide surface extending from an inner surface of the third outer wall in the first direction and in the separation direction, the first guide surface being slanted with respect to the second surface of the movable contact piece.

3. The electromagnetic relay according to claim 2, wherein the guide wall further includes a second guide surface, the second guide surface extending from an inner surface of the second outer wall toward the movable contact piece, the second guide surface facing the first guide surface in the first direction.

4. The electromagnetic relay according to claim 3, wherein the second guide surface is slanted with respect to the second surface of the movable contact piece, the second guide surface facing the second surface of the movable contact piece in the second direction.

5. The electromagnetic relay according to claim 2, wherein the guide wall further includes a third guide surface, the third guide surface being disposed to a side of the first fixed terminal, the third guide surface extending in the second direction from an inner surface of the third outer wall toward the first fixed terminal, the third guide surface facing the first guide surface in the second direction.

6. The electromagnetic relay according to claim 1, wherein the guide wall includes a third guide surface, the third guide surface being disposed to a side of the first fixed terminal, the third guide surface extending in the second direction from an inner surface of the third outer wall toward the first fixed terminal.

7. The electromagnetic relay according to claim 5, wherein the third guide surface extends from an inner surface of the third outer wall in the second direction and in the contact direction, the third guide surface being slanted with respect to the second surface of the movable contact piece.

8. The electromagnetic relay according to claim 1, wherein the guide wall includes a fourth guide surface, the fourth guide surface being disposed to a side of the movable contact piece, the fourth guide surface extending from an inner surface of the third outer wall in a third direction orthogonal to the first and second directions and in the separation direction, the fourth guide surface being slanted with respect to the second outer wall.

9. The electromagnetic relay according to 8, wherein the guide wall further includes a fifth guide surface, the fifth guide surface extending from an inner surface of the second outer wall toward the movable contact piece, the fifth guide surface facing the fourth guide surface in the third direction.

10. The electromagnetic relay according to claim 9, wherein the fifth guide surface is slanted with respect to the second surface of the movable contact piece, the fifth guide surface facing the second surface of the movable contact piece in the second direction.

11. The electromagnetic relay according to claim 8, wherein the guide wall further includes a sixth guide surface, the sixth guide surface being disposed to a side of the first fixed terminal, the sixth guide surface extending in the third direction from an inner surface of the third outer wall toward the first fixed terminal, the sixth guide surface facing the fourth guide surface in the second direction.

12. The electromagnetic relay according to claim 1, wherein the guide wall includes a sixth guide surface, the sixth guide surface being disposed to a side of the first fixed terminal, the sixth guide surface extending from an inner surface of the third outer wall toward the first fixed terminal in a third direction orthogonal to the first direction and the second direction.

13. The electromagnetic relay according to claim 11, wherein the sixth guide surface extends from an inner surface of the third outer wall in the third direction and in the contact direction, the sixth guide surface being and is slanted with respect to the second surface of the movable contact piece.

14. The electromagnetic relay according to claim 1, wherein the movable contact piece has a dimension that is smaller than a dimension of the first fixed terminal within the contact case in a third direction orthogonal to the first direction and the second direction.

15. The electromagnetic relay according to claim 1, wherein the movable contact piece has, in the second direction, a dimension that is smaller than a distance from the first fixed terminal to the second fixed terminal within the contact case.

16. The electromagnetic relay according to claim 1, wherein the second surface of the movable contact piece has a shape that is recessed toward the first outer wall.

17. The electromagnetic relay according to claim 1, further comprising:
an interlocking member disposed on the second surface of the movable contact piece, the interlocking member being configured to move in conjunction with the movable contact piece, the interlocking member having a shape recessed toward the second surface of the movable contact piece.

18. The electromagnetic relay according to claim 1, wherein the first fixed terminal includes a contact support portion configured to support the first fixed contact, and an extension portion extending from the contact support portion toward the third outer wall in a direction approaching the movable contact piece.

19. The electromagnetic relay according to claim 2, wherein the first fixed terminal is a plate terminal, the first fixed terminal including a contact support portion configured to support the first fixed contact, and a longitudinal portion disposed to a side of the movable contact piece, the longitudinal portion extending from the contact support portion toward the first guide surface.

20. The electromagnetic relay according to claim 1, wherein the contact case is comprised of material different from material of the guide wall.

21. The electromagnetic relay according to claim 20, wherein the guide wall is comprised of resin.

22. The electromagnetic relay according to claim 1, further comprising:
a magnet section for extending an arc toward the guide wall, wherein the arc occurs between the first fixed contact and the first movable contact.
